(19) United States
(12) Patent Application Publication
(10) Pub. No.: US 2005/0268116 A1
(43) Pub. Date: Dec. 1, 2005

(54) Electronic encryption system for mobile data (EESMD)

(76) Inventor: James Russell Jeffries, Sunnyvale, CA (US)

Correspondence Address: JAMES R. JEFFRIES, 1299 RIESLING TERRACE, SUNNYVALE, CA, 94087, US

(21) Appl. No.: 11/128,964

(22) Filed: May 12, 2005

Related U.S. Application Data
(60) Provisional application No. 60/571,069, filed on May 14, 2004.

(51) Int. Cl. H04L 9/32

(52) U.S. Cl. 713/192

(57) ABSTRACT

Encrypted mobile storage device which allows access for reading and writing of encrypted data. After the positive identification of the user takes place before the Host computer's communication is accepted. Because all data processing is on the EESMD, ease of use, security of data and most current Host Operating SYstem could provide access to the data. This allows this device to be accessed by the authorized user on virtually any computer system which provides a Powered External Interface for a Data Storage Devices which appropriately compliment this device.

### RELATED APPLICATIONS

The present application is a continuation-in-part application of U.S. provisional patent application Ser. No. 60/571,069, filed May 14, 2004, included by reference herein and for which benefit of the priority date is hereby claimed.

### FIELD OF THE INVENTION

I have invented a self-contained, portable, encrypted data storage system. The EESMD device makes possible, the carrying of data and applications in a secure manner, requiring only a computer with an industry standard Input/Output (I/O) communications port, having electrical power on at least one pin and one grounded pin.

### BACKGROUND OF THE INVENTION

The need to secure mobile personal and commercial information is in evidence by the News Services everyday. As a technological society, we are faced with carrying large amounts of very sensitive information combined with a increasing need to provide electronic identification. The loss of data may compromise personal information, customer records, company proprietary information, business practices, trade secrets, and many more forms of information which will hurt individuals, businesses or governments. To safe guard information an easy to use, highly secure environment is required.

Various ideas have been considered over the years with regards to the management and securing of information, in an effort to provide a simple, usable means of safeguarding data.

Examples of previous attempts to provide information security using encryption techniques include: File Encryption programs, Computer Hard Disk Drive (HDD) like “Pretty Good Protection”(PGP) or “ForYourEyesOnly” and many other computer programs.

Current encryption systems are very restrictive in operation and therefore prone to disuse. Some of the reasons these applications fall in to disuse are: Long passwords or phrases; Too many passwords to remember; Frequent password changes requireing a previously unused password. Combine those with the fact that we would like to have something easy to remember, causing us to select passwords that are easily guessed. The overwhelming complexity of the systems and frustrating results encountered by users cause users to by-pass these programs.

Examples of computer restrictions are found in the types and versions required of: devices, components, drivers, encryption software, Operating System (OS), OS Version, Central Processing Unit CPU) as well as System Permissions, when used for encrypting/decrypting data on current Removable Electronic Storage Device (RESD). Then, you must also meet these restrictions on any computer system you wish to use for information access.

Even if a user would have the appropriate hardware and software combination, the password and “Keys” can be captured by “Key Loggers” and “Communication Port Sniffers” which maybe found in computer “WORMS” and “VIRUSES” or used by dishonest by System Administrators “Snoops and Spies”.

For these reasons the user usually finds that they do not have access to the information when it is needed and so the information remains in an unprotected state.

RESD's are represented by solid-state memory (Electronic Programmable Read Only Memory or EPROM), flash memory (NAND based on EE (Erasable)PROM) or portable disk storage units. Connection to a host computer may come in the any form which provides storage using an external device.

The restrictions described above result in very limited portability and are primarily used only when absolutely required.

It is therefore an object of the invention to . . . Provide a self-contained, encrypted mobile storage device.

It is another object of the invention to . . . Provide activation of the device by a bio-metric sensor like a finger-print scanner.

It is another object of the invention to . . . To use the information from the scanner to activate the encryption algorithms after the device is powered on and prior to access to data being granted.

It is another object of the invention to . . . To perform after activated internally, all necessary functions for the encryption/de-cryption of data on stored or read from this device by answering Disk Drive read/write commands from the Host System.

### SUMMARY OF THE INVENTION

In accordance with the present invention, there is provided . . .

My invention provides high portability, improved usability, and effective security for information stored on its RESD component. The EESMD uses the following components: Bio-metric sensor currently a finger print scanner), a CPU, drive controller, external I/O controller, electronic storage device (NAND Memory currently prefferred), Read Only Memory (ROM), Static Memory (CACHE), Read Addressable Memory (RAM), Basic Input/Output System (BIOS ) chip, encryption software and a user feedback component (Light Emitting Diode—currently).

The resulting actions of the user are: Connect the EESMD to the Host's correct I/O Port, the Host reads the newly attached device and discovers a Removable Drive Storage has been attached. If access is attempted prior to Activation, the Host reports that the drive is not ready. The user actives the EESMD by correctly applying finger print(s) to the EESMD. Once Activated the Host system now is able to read and write to the device as though no security is in use. However, information written to this device is encrypted and when read de-crypted by the EESMD without further passwords or software required.

### BRIEF DESCRIPTION OF THE DRAWINGS

A complete understanding of the present invention may be obtained by reference to the accompanying drawings, when considered in conjunction with the subsequent, detailed description, in which:

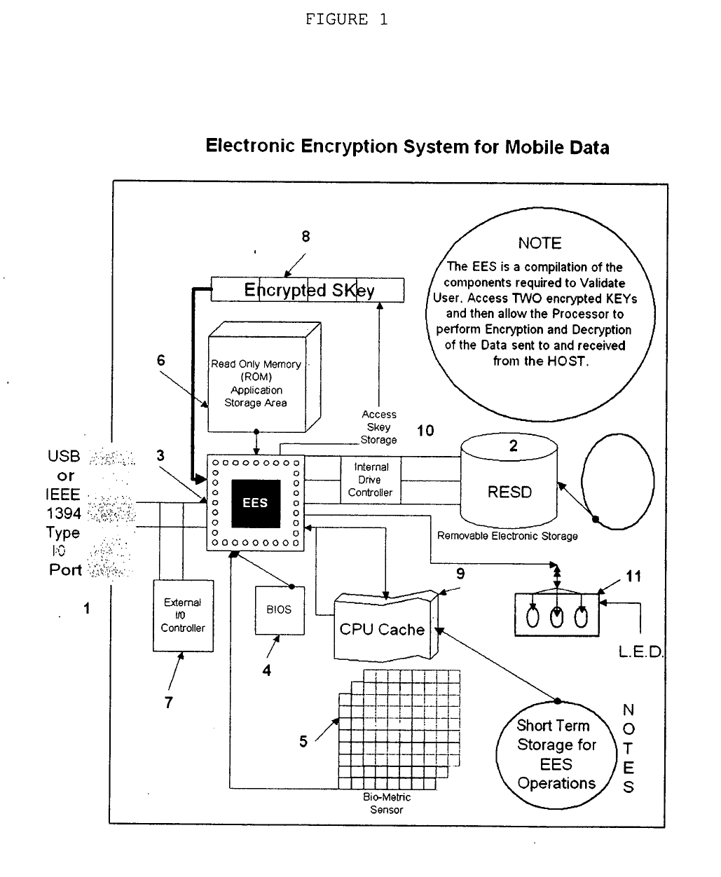

FIG. 1 is a top view of a Drawing—Reference Numerals:
1. Input/Output Port to Host
2. Removable Electronic Storage Device (RESD), for mass storage of encrypted data.
3. Central Processing Unit (CPU), performs data manipulations.
4. Basic Input/Output (I/O) System (BIOS) mantains the discription of system and its operation.
5. BioMetric Sensor reads the biological data transmit same in a numeric value that can be acted upon by the system.
6. Read Only Memory location, this is portected storage for the applications and other data.
7. I/O Controller which receives and sends information to the Host.
8. Secret Key Storage Area.
9. CPU cache, provides very high speed short term storage.
10. Internal RESD controller, manages the connection to the mass storage areas.
11. Light Emitting Diode.

For purposes of clarity and brevity, like elements and components will bear the same designations and numbering throughout the FIGURES.

### DESCRIPTION OF THE PREFERRED EMBODIMENT

FIG. 1 is a top view of a Drawing—Reference Numerals:
1. External Input/Output Port 1 to Host provides communications with the Host Computer which also powers the EESMD
2. Electronic Data Storage 2, for mass storage of encrypted data. An example of this memory type is NAND memory available from SanDisk Corporation or M-Systems.
3. Electronic Encryption System 3 (EES) is a central processing unit (CPU) and performs data manipulations as well as other programmed tasks.
4. Basic Input/Output (I/O) System (BIOS 4) mantains the discription of system and its operation. One component providing acceptable serive is provided by FreeScale as the “ColdFire” processor which includes various Encryption Applications with the processor.
5. Bio-Metric Sensor 5 reads the biological data transmit same in a numeric value that can be acted upon by the EES for authentication and encryption keys. Examples of these sensors are available from Authentec Corporation and from UPEK, INc.
6. Read Only Memory 6 location, this is portected storage for applications and other data.
7. External I/O Controller 7 controls the receiving and transitting of information to the Host.
8. Encrypted Secret Key 8 Storage Area—Maybe located in another location, or not used at all depending upon the Encryption application used.
9. EES(CPU) cache 9, provides very high speed short term storage.
10. Internal Drive Controller 10, manages the connection to the mass storage areas, including but not limited to read, write, load balancing, Table of Contents and monitors performance of the storage areas.
11. Light Emitting Diode (L.E.D.) 11 provides user communications and feedback regarding the status of the EESMD and the current state of access control.

The Host provides: An industry standard, powered I/O Port, from which the EESMD acquires sufficient power to operate. It is also incumbent on the Host to operate the port and provide the tools required by its operating system and hardware. Examples of possible I/O Ports that could be used are: USB 1.1, USB 2.0, PCMCIA, CF+ (Compact Flash) or IEEE 1394 Fire-wire. The EES device appears to the Host as a Disk Drive (DD) Unit and when unlocked will perform as a DD to answer data and drive read/write commands as with any such storage unit. The Host will perform DD functions such as formatting, and partitioning of the unit, as required by the Host Operating System. The difference is that the DATA will be encrypted and decrypted as is moves past the EES.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A “electronic encryption system for mobile data” eesmd). for creation of a stand-a-lone secure electronic encryption device to protect mobile data. comprising:
a New Attribute 1 external input/output port, for system power and data request from host system;
a Mass Storage Location electronic data storage, for read/write mass storage location;
a Central Processing Unit electronic encryption system, for this unit provides user validation, encryption/decryption of data and has the duties of a central processing unit in this system;
a Basic Input/Output System bios, for this contains the internal description and drivers for the cpu, memory, i/o ports and starts the power on self test to validate the system, rigidly connected to said Electronic Encryption System;
a Reads the Bio-metric data, Determines when a correct scan has occured, Communicates with the EES controller bio-metric sensor, for reads its data and reports findings to ees (cpu), rigidly connected to said Electronic Encryption System;
a Long Term Storage Area, Contains Drivers and Applications for EES read only memory, for provides a storage area accessible by the ess, which contains drivers and various applications in a read only memory format, rigidly connected to said Electronic Encryption System; and
a Short Term, Fast Random Access Memory ees (cpu) cache, for used to cache instructions and data during ees (cpu) operations, rigidly connected to said Electronic Encryption System.

2. The “electronic encryption system for mobile data” (eesmd). as recited in claim 1, further comprising:
a Controls how the Input/Output port functions external i/o controller, for this controls the access and function of the external interface ports on this system. while it is required to have the external i/o ports controlled, this function maybe added to the ees or other controller, rigidly connected to said External Input/Output Port, and rigidly connected to said Electronic Encryption System.

3. The “electronic encryption system for mobile data” (eesmd). as recited in claim 1, further comprising:
a Memory Location for the storage of the encrypted secret key, for maybe located in another location, or not used at all depending upon the encryption application used, rigidly connected to said Electronic Encryption System.

4. The “electronic encryption system for mobile data” (eesmd). as recited in claim 1, further comprising:
an Internal Drive Controller internal drive controller, for provides all descriptions and processes required for the electronic storage system to function. these functions maybe added to ess or other controller curcuits, rigidly connected to said Electronic Data Storage, and rigidly connected to said Electronic Encryption System.

5. The “electronic encryption system for mobile data” (eesmd). as recited in claim 1, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

6. The “electronic encryption system for mobile data” (eesmd). as recited in claim 2, further comprising:
a Memory Location for the storage of the encrypted secret key, for maybe located in another location, or not used at all depending upon the encryption application used, rigidly connected to said Electronic Encryption System.

7. The “electronic encryption system for mobile data” (eesmd). as recited in claim 2, further comprising:
an Internal Drive Controller internal drive controller, for provides all descriptions and processes required for the electronic storage system to function. these functions maybe added to ess or other controller curcuits, rigidly connected to said Electronic Data Storage, and rigidly connected to said Electronic Encryption System.

8. The “electronic encryption system for mobile data” (eesmd). as recited in claim 2, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

9. The “electronic encryption system for mobile data” (eesmd). as recited in claim 3, further comprising:
an Internal Drive Controller internal drive controller, for provides all descriptions and processes required for the electronic storage system to function. these functions maybe added to ess or other controller curcuits, rigidly connected to said Electronic Data Storage, and rigidly connected to said Electronic Encryption System.

10. The “electronic encryption system for mobile data” (eesmd). as recited in claim 3, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

11. The “electronic encryption system for mobile data” (eesmd). as recited in claim 4, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

12. The “electronic encryption system for mobile data” (eesmd). as recited in claim 6, further comprising:
an Internal Drive Controller internal drive controller, for provides all descriptions and processes required for the electronic storage system to function. these functions maybe added to ess or other controller curcuits, rigidly connected to said Electronic Data Storage, and rigidly connected to said Electronic Encryption System.

13. The “electronic encryption system for mobile data” (eesmd). as recited in claim 6, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic-Encryption System.

14. The “electronic encryption system for mobile data” (eesmd). as recited in claim 7, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

15. The “electronic encryption system for mobile data” (eesmd). as recited in claim 9, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

16. The “electronic encryption system for mobile data” (eesmd). as recited in claim 12, further comprising:
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.

17. A “electronic encryption system for mobile data” (eesmd). for creation of a stand-a-lone secure electronic encryption device to protect mobile data. comprising:
a New Attribute 1 external input/output port, for system power and data request from host system;
a Mass Storage Location electronic data storage, for read/write mass storage location;
a Central Processing Unit electronic encryption system, for this unit provides user validation, encryption/decryption of data and has the duties of a central processing unit in this system;
a Basic Input/Output System bios, for this contains the internal description and drivers for the cpu, memory, i/o ports and starts the power on self test to validate the system, rigidly connected to said Electronic Encryption System;
a Reads the Bio-metric data, Determines when a correct scan has occured, Communicates with the EES controller bio-metric sensor, for reads its data and reports findings to ees (cpu), rigidly connected to said Electronic Encryption System;
a Long Term Storage Area, Contains Drivers and Applications for EES read only memory, for provides a storage area accessible by the ess, which contains drivers and various applications in a read only memory format, rigidly connected to said Electronic Encryption System;
a Controls how the Input/Output port functions external i/o controller, for this controls the access and function of the external interface ports on this system. while it is required to have the external i/o ports controlled, this function maybe added to the ees or other controller, rigidly connected to said Electronic Encryption System, and rigidly connected to said External Input/Output Port;
a Memory Location for the storage of the encrypted secret key, for maybe located in another location, or not used at all depending upon the encryption application used, rigidly connected to said Electronic Encryption System;
a Short Term, Fast Random Access Memory ees (cpu) cache, for used to cache instructions and data during ees (cpu) operations, rigidly connected to said Electronic Encryption System;
an Internal Drive Controller internal drive controller, for provides all descriptions and processes required for the electronic storage system to function. these functions maybe added to ess or other controller curcuits, rigidly connected to said Electronic Encryption System, and rigidly connected to said Electronic Data Storage; and
an User Feedback Interface light emitting diode (l.e.d.), for a user feedback process is required, but it maybe in another form of display, ie. a display screen maybe added to the eesmd or communications maybe sent to the host system for display of status, rigidly connected to said Electronic Encryption System.
